(19) United States
(12) Patent Application Publication
(10) Pub. No.: US 2006/0203880 A1
(43) Pub. Date: Sep. 14, 2006

(54) Water stream comfort indication device

(76) Inventor: Ronald F. Batcho SR., Charlotte, NC (US)

Correspondence Address: FRANK J. PITA, 1413 CARYWOOD DRIVE, CARY, NC, 27513, US

(21) Appl. No.: 11/077,778

(22) Filed: Mar. 11, 2005

(51) Int. Cl. G01K 13/00; G01K 1/14; G01K 1/08

(52) U.S. Cl. 374/147

(57) ABSTRACT

Devices for indicating when a water stream at some temperature flowing through a plumbing fixture is comfortable for at least one user to physically contact. Devices include at least a control unit, a temperature sensor, and an output device. The temperature sensor senses a temperature representative of the water stream. The control unit compares the temperature representative of the water stream to a preset temperature or range of temperatures representative of the water stream being comfortable for some user to physically contact. The output device affirmatively indicates to users that the water stream is comfortable once the sensed temperature representative of the water stream matches or is within the preset range of representative temperatures. A user interface is provided in some embodiments. Abstract is provided only for searching purposes, and is not intended to narrow the scope of the present invention as defined by the attached claims in any way.

### FIELD OF THE INVENTION

The present invention relates to thermal measurement technology, and more particularly to devices for measuring the temperature of a water stream and indicating to a user that it is comfortable to physically contact the water stream.

### BACKGROUND OF THE INVENTION

Human interaction with water at various temperatures can have a number of different results and consequences. One common source of human interaction with water is when someone physically contacts a water stream. For example, someone may contact a water stream by washing his or her hands in a sink, by taking a shower, taking a bath in a tub, or the like. Commonly, the water stream originates from a source that mixes relative amounts of hot and cold water into the stream, which thereby determines the temperature of the water stream. For instance, one may contact a premixed water stream by setting the hot valve and the cold valve in sink faucet. As a further example, one can contact a premixed water stream in a shower using a single valve that mixes hot and cold water to control the flow and temperature of the water stream. Preferably, the water stream should not be uncomfortable for a person to physically contact. At times, the water stream may either be too hot or too cold for a person to contact. Scalding or burning can result if someone physically contacts a water stream that is too hot. Alternatively, contacting a water stream that is too cold can shock the person making contact with the water stream. Regardless of whether the water is too hot or too cold, contacting an uncomfortable water stream can provide an unpleasant surprise to a person. Injuries or accidents may result from physically contacting uncomfortable water streams, especially for older and younger persons who may not be as tolerant as more robust adults of water streams that are too hot or too cold.

In addition, it is all too common for persons encountering an uncomfortable water stream to modify the mixture of hot and cold water seeking to end the unpleasant experience. This can result in wasted time, wasted water, and added cost. Clean water is becoming scarcer and more expensive as growing populations increasingly demand more water. Fumbling with the hot and cold mixtures in response to an uncomfortable water stream can be frustrating and wasteful. Commonly, the amount of hot water available at a given time is a finite resource that can be exhausted all too quickly, as parents of some children will painfully attest. Once the amount of then available hot water is consumed, a water stream may become uncomfortably cold without remedy. There have been a number of attempts in the past to solve problems associated with contacting an uncomfortable water stream by using active means that control the mixture of hot and cold water, often in response to some feedback information regarding the temperature of the output water stream. Many of these active water mixing devices are elaborate and relatively costly. Typically, these active devices must be built into plumbing as a new home is being built, or will require considerable re-plumbing in existing homes to allow regulating the output water temperature of a water stream. Often, these active devices require a licensed plumber or a very capable homeowner with electrical wiring skills and substantial tools for proper installation.

A number of active water devices have been developed. One clever active device diverts a water stream away from a human user if the water is either too hot or too cold. Once water is within a given temperature range, this active device redirects the water stream back to the human user such that they will not be startled or scalded. However, this active device can waste water and thus be expensive to operate. Further, this is a relatively complex and expensive active mixing device that requires considerable electrical and plumbing work in order to be installed before it can control the water stream's output temperature. Many of these active devices are beyond the ability of the typical consumer to purchase or install easily. In addition, some passive devices that do not actively mix the hot water source and the cold water source have also been developed.

A few of these passive devices simply displayed the temperature of the water stream, or displayed a range of temperature corresponding to the water stream. Merely knowing the temperature of a water stream or knowing that a water stream is in some temperature range oftentimes is simply not enough to avoid an uncomfortable water stream. Human beings vary a great deal as a species, and no two individuals are alike. Further, our sense of what is too hot and what is too old may vary between different individuals. In addition, whether something is too hot or too cold is a sensation that can vary over time in the same individual for many reasons. For example, water at 102 degrees Fahrenheit may be too hot for one person but perfect for another at a given time. For instance, water at 101 degrees Fahrenheit may be too hot for someone in dog days of summer but perfectly satisfactory for that same person on a cold winter day when they better appreciate the warmth.

Yet other passive devices displayed an indication of when the water was too hot, too cold, or either too hot or cold. Again, these water measurements are based on absolute temperature ranges that may not necessarily relate to the sensations of a given individual contacting a water stream. For example, a water temperature that is too hot for someone may be fine for someone else and too cold for yet another person. Further, a certain water temperature may be fine for someone to contact one day, and uncomfortably hot or uncomfortably cold the next day. Someone may not care what the exact water temperature is so long as it neither scalds nor shocks his or her senses. It would be advantageous for persons to minimize or avoid having to physically contact water streams that are uncomfortable, whether they are too hot or too cold. Further, existing devices can also waste water and time since they inform someone when they should not physically contact a water stream. An unmet need exists for better ways in which persons can interact with a pre-mixed water stream. It would be advantageous to recognize that people are different, and that their senses vary both over time and between persons. Enabling better human interaction with a water stream in ways that are relatively inexpensive and easy to install or retrofit into plumbing would also be advantageous. It would be desirable to develop a better paradigm for human interaction than merely using the temperature of a water stream given the problems noted above. Persons would welcome the advantage of knowing when contacting a water stream will neither scald nor shock their senses. Addressing at least some of the above would allow saving water, saving time, and reducing costs associated with physically contacting a water stream that is not uncomfortable. Readers should be advised that this Background of the Invention is provided merely for explanatory purposes, and is not intended to limit the scope of the present invention as defined by the attached claims in any way.

### SUMMARY OF THE INVENTION

The present invention, as described in various embodiments and claimed herein, provides water stream comfort indication devices that seek to address at least some of the problems and needs above while attempting to deliver one or more of the advantages discussed previously. Embodiments of the present invention are provided that interface with at least one user allowing presetting of one or more comfortable water temperature ranges or a single comfortable water temperature that can vary between users or can vary for a given user over time. Some water stream comfort indication device embodiments are provided by the present invention that affirmatively indicate to at least one user when a water stream is comfortable to physically contact. As such, water stream comfort indication device embodiments strive to make contact with a water stream less traumatic, safer, easier, and more cost effective than was heretofore possible.

In a first embodiment, the present invention provides a device for indicating to a person using the device whether a water stream flowing through a plumbing fixture is comfortable to physically contact. The device embodiment includes therein at least a temperature sensor, a control unit, and an output device. Its temperature sensor is operably connected to at least the plumbing fixture such that it can thereby sense a temperature representative of the water stream flowing through the plumbing fixture. In addition, the control unit is operably connected to at least the temperature sensor so that it can receive therefrom the temperature representative of the water stream as sensed. The aforementioned output device is operably connected to at least the control unit. Some embodiments further provide a user interface for allowing at least one user to preset a water temperature range representative of the water stream, such that a water stream sensed to be within the preset temperature range is comfortable for at least one person using the device to physically contact. Optionally, a user may preset a representative water temperature range in the control unit, without requiring a user interface. In addition, a comfortable water temperature or a range of comfortable water temperatures may be preset. In operation, the control unit compares the temperature representative of the water stream as sensed with the water temperature range preset by the user. The output device indicates to at least one user that the water stream is comfortable for a user to physically contact, once the control unit determines that the temperature representative of the water stream sensed is within the water temperature range preset by a user. For some embodiments, it is assumed that the water stream flowing through the plumbing fixture is previously mixed from hot and cold water sources to some temperature prior to interfacing with the first device embodiment of the present invention. Of course, other embodiments may be used to determine whether a water stream having an unknown temperature may be comfortable for a user to physically contact.

Other device embodiments of the present invention further describe the temperature sensor, the control unit, the output device, the user interface, and the operable connections between elements of the device embodiments. Additional details regarding the user interfaces and power sources of the present invention are described in further device embodiments. Various other features comprising further device embodiments are disclosed as well. In addition, means plus function embodiments related to the first device embodiment and other device embodiments are provided by the present invention. These means embodiments should be construed in accord with the structures disclosed herein that can perform each given function as well as those equivalents thereof as known to those skilled in the art. Alternative embodiments of the device include an output device that is capable of providing at least one of an audible indication and a visual indication when the water stream is comfortable for a user to physically contact. Possible additional indications to a user, such as indications that the water stream may be too hot or too cold, may be provided by the output device are encompassed in another class of device embodiments. The Summary of the Invention is provided herein merely as a general overview of the invention and is not intended to limit the scope of the present invention as defined by the attached claims in any way. Other aspects and features of the present invention will become apparent to those of ordinary skill in the art, upon review of the following description of specific embodiments of the present invention in conjunction with the accompanying Figures.

### BRIEF DESCRIPTION OF THE FIGURES

FIG. 1 is a diagram illustrating water stream comfort indication devices according to some embodiments of the present invention.

FIG. 2, including FIGS. 2(a), 2(b), 2(c) and 2(d), illustrate temperature sensors and their interaction with a water stream according to some embodiments of the present invention.

FIG. 3 illustrates control units according to some embodiments of the present invention.

FIG. 4 illustrates output devices according to some embodiments of the present invention.

FIG. 5 illustrates user interfaces according to some embodiments of the present invention.

FIG. 6 illustrates power sources according to some embodiments of the present invention.

The Brief Description of the Figures above and the following Detailed Description of the Invention are provided for illustrative and descriptive purposes only, and neither is meant to limit the scope of the present invention as defined by the attached claims in any way.

### DETAILED DESCRIPTION OF THE INVENTION AND BEST MODE

The present invention will now be described more fully hereinafter with reference to the accompanying illustrative figures, in which various embodiments of the invention are shown. This invention may, however, be embodied in many different forms and should not be construed as limited to the embodiments set forth herein; rather, these embodiments are provided so that this disclosure of the present invention will be thorough and complete, and will fully convey the broad scope of the invention to those skilled in the art. Unless otherwise expressly limited, all terms used herein including technical and scientific terms, whether defined herein or not, are intended to have the broadest possible meaning as understood by one of ordinary skill in the art. Although specific terms are employed herein, they are used in a generic and descriptive sense only and not for purposes of limiting the scope of the present invention as defined by the attached claims in any way. It will be further understood that terms not explicitly defined herein should be interpreted as having the broadest possible meaning or meanings found in commonly used dictionaries, consistent with their meaning in the context of the relevant art. Some terms will be explicitly defined herein and used to describe embodiments of the present invention to those skilled in the art. Terms defined explicitly herein should be interpreted as the broader of their definition herein and their dictionary meanings. These defined terms should accordingly be construed according to their broadest possible meaning to skilled artisans in this field of technology.

The Figures are provided for illustrative purposes for teaching purposes and to assist in understanding the present invention, and should not be viewed as precision blueprints or perfectly scaled drawings. In the drawings provided, the dimensions of features or regions may be exaggerated for clarity, readability, or other reasons. Features found in the Figures may not be exactly to scale. The Figures are provided to show example embodiments of the present invention. Thus, embodiments of the present invention should not be construed as limited solely to the particular Figure or Figures illustrated herein but may include variations and deviations from many sources. Like numbers refer to like features or elements throughout. As used herein the term “and/or” includes any and all combinations of one or more of the associated listed items. Further, as used herein the term “at least” includes the number specified plus more than the number specified.

As used herein, the singular forms “a”, “an” and “the” are intended to include the plural forms as well, unless the context clearly indicates otherwise. It will be further understood that the terms “comprises” or “comprising,” when used in this specification, specify the presence of stated features, steps, operations, elements, and/or components, but do not preclude the presence of one or more additional features, steps, operations, elements, components, and/or combinations thereof. Moreover, terms such as “horizontal”, “vertical” and “perpendicular” indicate general directions or relationships rather than precise 0° or 90° orientations. Ranges and angles are approximate and are provided merely to teach the present invention. The terms “comfort” or “comfortable” as used herein are meant to include when a fluid is at a fluid temperature that feels soothing or comfortable to a particular user's touch or senses at a given point in time, when fluid is within a defined range of fluid temperatures that feel soothing or comfortable to a particular user's touch or senses at a given point in time, both of the preceding, as well as including various dictionary meanings of “comfort” and “comfortable”. The terms “uncomfortable” as used herein includes its dictionary meanings as well as including meanings related to not providing “comfort” and “comfortable” as used herein. The present invention, as illustrated in numerous water stream comfort indication device embodiments, will hereafter be described more fully.

Embodiments of the present invention sense a water stream in order to determine whether the water stream might be comfortable for a given user to physically contact at a certain time. The present invention passively senses the water stream as it is encountered, and does not modify the temperature of the water stream. In some embodiments, the present invention may be used by someone who is unable to control the temperature of the water stream. For example, the present invention may be used to determine whether a water stream from natural sources, such as water from a river, geyser, or the like could be comfortable to physically contact. One could use the present invention to determine whether a water stream may be comfortable for someone to physically contact when the mix of hot and cold water is beyond the control of the user. For example, a user may physically contact water streaming from plumbing but may not have access to any hot or cold water controls. In other embodiments, the present invention may be used by someone who is able to control the temperature of the water stream. For instance, a user might control the mixture of hot and cold water through means other than provided by the present invention and use the present invention seeking a comfortable water stream to contact.

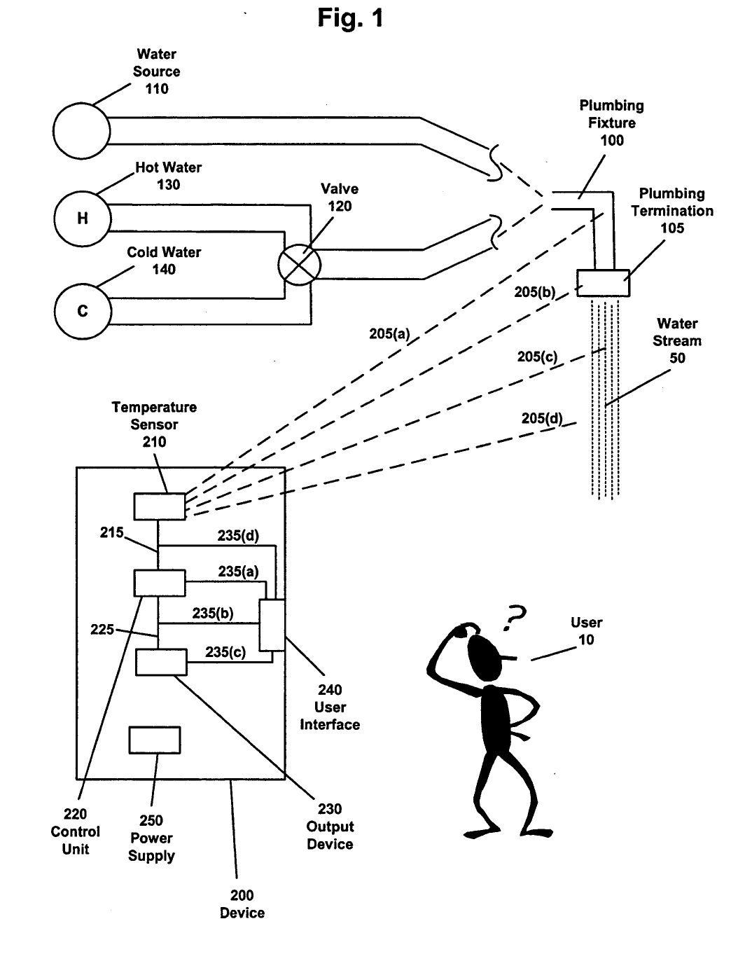

As such, the reader is referred to FIG. 1 which describes one water stream comfort indication device embodiment, such as 200 for example, according to the present invention. First we will describe some details regarding the water stream and its possible sources. Water stream 50 as shown flows through a plumbing fixture such as 100. The plumbing fixture can be manifested in a number of ways as used with the present invention. For instance, plumbing fixture 100 could simply be a pipe or conduit conveying the water stream to the user. Alternatively, the plumbing fixture could also optionally include any known plumbing termination, such as 105 shown in the Figure, used to ultimately deliver a water stream to a user. Examples of plumbing terminations include but are not limited to an aerator nozzle or spout providing a water stream in a sink, some other output device for water from a faucet or tap, a firmly attached shower head, a firmly attached yet rotating shower head allowing a user to alter the direction of a water stream, a handheld shower head moveably attached through some flexible pipe or conduit, a spout or output for water stream in a tub, and others. The present invention may be used wherever a user may contact a water stream, such as in a sink, shower, bath, tub, outdoors, or the like. Referring anew to FIG. 1 and the preceding discussion, as noted the water stream entering plumbing fixture 100 could originate from a water source, such as 110 shown, from which the user cannot control the temperature or relative mixture of hot and cold water of the water stream. Alternatively, the water stream entering plumbing fixture 100 could originate from some source, such as valve 120, which is accessible to the user such that they can control the relative mixture of hot and cold water or the temperature of the water stream. As shown in the Figure, for example, a user may be able to alter the relative proportions of hot water 130, cold water 140, or both. For example, a single valve can control the relative amounts of hot and cold water that are mixed into a water stream, such as seen in some shower valves. As a further example, individual hot water and cold water valves might be used to control the relative mixture hot and cold water found in a water stream.

In addition, FIG. 1 illustrates an example embodiment of a water stream comfort indication device 200 according to the present invention. The device indicates whether a water stream 50 flowing through a plumbing fixture is comfortable for at least one user, such as user 10 for example, to physically contact. This example embodiment 200 comprises a temperature sensor 210, a control unit 220, an output device 230, and a user interface 240. The temperature sensor is operably connected in some way to at least the plumbing fixture, such that the temperature sensor 210 can thereby sense a temperature representative of the water stream. In addition, the control unit 220 is operably connected in some way to at least the temperature sensor, to allow the control unit to receive from the temperature sensor the sensed temperature representative of the water stream flowing through the plumbing fixture. The output device 230 is operably connected in some way to at least the control unit 220, while the user interface 240 is operably connected in some way to at least one of the temperature sensor 210, the control unit 220, and the output device 230. Further, the output device can provide at least one of an audible indication and a visual indication to the user. For instance, the output device 230 could illuminate a light, project an audible sound, or both to provide an indication to a user. A user of the device embodiment 200 can preset a water temperature range representative of the water stream such that a water stream sensed within the range is comfortable for that user to physically contact. Of course, a single comfortable water temperature may be preset in lieu of, or in addition to, a water temperature range. In operation, the control unit compares the realtime temperature representative of the sensed water stream to determine if the sensed water stream is within the comfortable temperature range preset by the user. The output device 230 provides an affirmative indication to the user that the sensed water stream is comfortable for the user to physically contact, once the control unit 220 determines the temperature representative of the water stream sensed to be within the comfortable water temperature range preset by the user. In some device embodiments, the water stream is previously mixed prior to interfacing with the device embodiment, while in other embodiments, the water stream is encountered from a source providing a water stream at a given temperature.

A comfortable water temperature as well as a range of comfortable water temperatures can be preset in various ways in device embodiments of the present invention. As noted, a single comfortable water temperature or a range of comfortable water temperatures may be preset in some device embodiments. In addition, the water temperature range optionally may include a comfortable water temperature therein. Thus, a user could preset by interacting with the control unit 220, the user interface 240, output device, or combinations thereof. In addition, a comfortable water temperature or range could be preset by a user interacting with device embodiments using their sense of touch while physically contacting a water stream. For example, a user could press a button once to allow a device embodiment to sense a water stream realtime, could release the button or press the button again to indicate a comfortable water temperature, and could press or release buttons as needed to preset the hot and cold limits of a comfortable water stream's temperature range. In this case, it is possible that a user may preset a comfortable water temperature and range without ever actually knowing the water stream temperature by relying on their sense of touch. Of course, a user might know the temperature of a water stream they contact as they preset a comfortable temperature and range. For instance, a user might decide that the water stream temperature is comfortable and look at the output device to determine that the comfortable water stream temperature is 99.7 degrees F. Further, a user could preset a comfortable water temperature and range for a water stream without physically contacting the water stream, such as by presetting actual water temperatures in a device embodiment. As such, a user could preset a comfortable water temperature range between 95.2 degrees F. and 100.3 degrees F. without ever contacting a water stream at those temperatures. Other means of input, such as voice or biometrics, could be used as well. As merely but two examples, a user's thumbprint could be sensed to identify a user, or a user could speak a command such as “set low temperature” to have the device embodiment use voice recognition to preset the low end of a water temperature range being physically contacted by a user. In addition, many other ways could be used to interact with a device embodiment to preset a comfortable water temperature, a comfortable water temperature range, or both for various device embodiments within the scope of the present invention.

Some water stream comfort indication device embodiments only include a temperature sensor 210, control unit 220, and an output device 230. An example of this embodiment is illustrated in FIG. 1 as example water stream comfort indication device 200 if the user interface 240 is omitted. In this case, a user may interact with the control unit to preset a comfortable water temperature range. As before, the device embodiment indicates to a user when a water stream flowing through a plumbing fixture is comfortable for the user to physically contact. The temperature sensor 210 is operably connected in some way to at least the plumbing fixture, such that the temperature sensor can thereby sense a temperature representative of the water stream. Further, the control unit 220 is operably connected in some way to at least the temperature sensor, such that it can receive from the temperature sensor 210 the temperature representative of the water stream sensed. The control unit compares the temperature representative of the water stream sensed with a water temperature range previously preset by the user as comfortable to physically contact. Of course, a preset water temperature could also be compared against a realtime sensed temperature of a water stream. The output device 230 affirmatively indicates to the user that the water stream sensed is comfortable for the user to physically contact when the temperature of the water stream sensed is within the water temperature range preset by the user. One or more users may preset and use the device embodiment as indicated.

Other water stream comfort indication device embodiments similar to example device 200 include means for sensing temperature, means for controlling, and means for outputting for indicating whether a water stream flowing through a plumbing fixture is comfortable for a user to physically contact. The means for sensing temperature is operably connected in some way to at least the plumbing fixture. As such, the means for sensing temperature can thereby sense a temperature representative of the water stream. In addition, the means for controlling is operably connected in some way to at least the plumbing fixture so that it can receive therefrom the temperature representative of the water stream sensed. The means for controlling compares the temperature representative of the water stream sensed realtime with a water temperature range previously preset by the user as comfortable to physically contact. The means for outputting is operably connected in some way to at least the means for controlling. Thus, the means for outputting affirmatively indicates to the user that the water stream sensed is comfortable for the user to physically contact when the temperature representative of the water stream sensed is within the water temperature range preset by the user. Some related embodiments further include means for interfacing, operably connected in some way to at least the means for controlling. The means for interfacing allows a user to preset a water temperature range in a more user friendly manner such that the water stream within the water temperature range is comfortable for a user to physically contact. Again, the water stream may be previously mixed prior to interfacing with the device embodiment, or the water stream may be encountered from a source providing a water stream at a given temperature. One water stream temperature, a range of water stream temperatures, or both may be preset and compared against the realtime sensed temperature of a water stream. Further, more than one user may preset water temperature ranges and use these device embodiments. Those skilled in the art should note that the various means should be interpreted according to the corresponding structures described herein that can perform the associated function, also including all equivalents thereof as might be understood by those skilled in the associated arts and technologies.

Looking further at FIG. 1, we will describe features related to various embodiments of the present invention. One representative device embodiment is shown as 200 in the Figure. The device embodiment 200 includes a temperature sensor 210, a control unit 220, and an output device 230. As noted, some device embodiments additionally include a user interface 240. Although these elements of the device embodiment are shown as separate items in the Figures, these elements may also be combined into one or more components such as an embedded microprocessor, integrated circuit, or the like as will be appreciated by those skilled in the art. Further, it is possible that all elements comprising a device embodiment could be integrated into a single component part. Levels of integration between a single component and a number of separate components are possible in other embodiments. Those skilled in the art will understand that the various elements of a device embodiment may be combined or packaged in many different permutations, combinations, and levels of device or system integration without departing from the scope of the present invention.

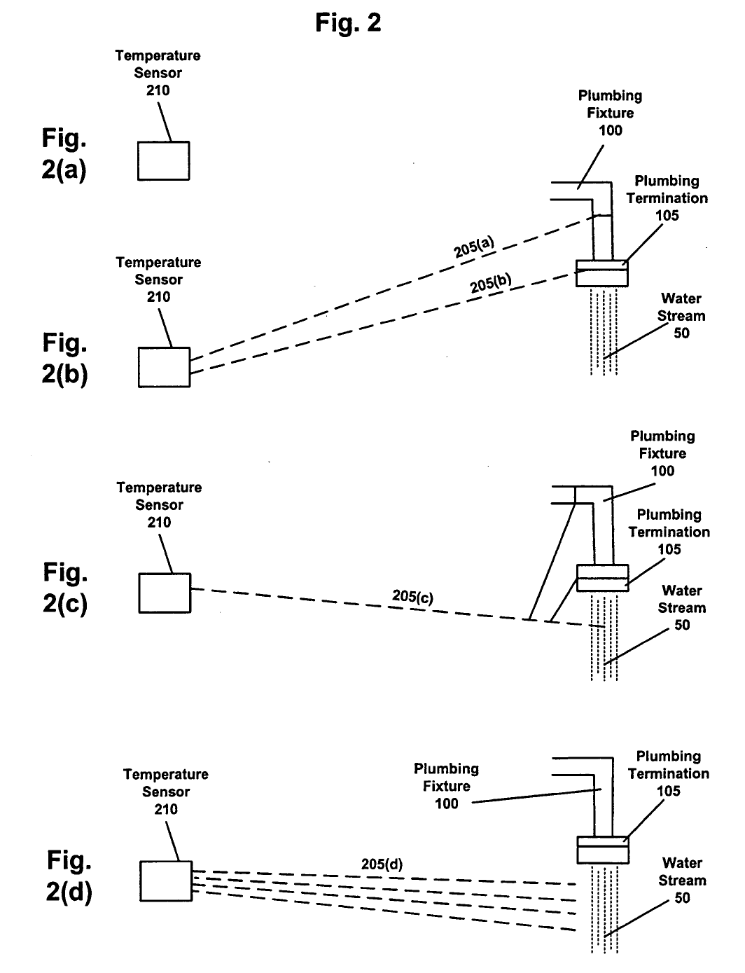

We will now describe the temperature sensors that may be used in device embodiments according to the present invention. For example, representative temperature sensors are shown as feature 210 in FIGS. 1, 2(a), 2(b), 2(c), and 2(d) and the like. For purposes of the present invention, the temperature sensors used therein function to measure or sense a realtime temperature representative of a water stream, such as water stream 50, at various points in time. The temperature representative of the water stream may be determined in several ways and using a number of technologies. At times, the temperature representative of the water stream may be a temperature measured directly from the water stream itself by a temperature sensor or temperature sensor component. The temperature representative of a water stream may be the actual temperature of the water stream itself. For example, a temperature probe or thermometer may be used in temperature sensor 210 to measure the water stream directly by being immersed therein. As an illustration of this, in operable connection 205(c) a temperature probe or the like may be immersed in water stream 50 as shown such that the actual temperature of the water stream can be measured by the temperature sensor 210. As a further example, an infrared temperature sensor pointed generally in the direction of the water stream may measure the water stream's temperature directly without physically contacting the water stream. For instance, in operable connection 205(d) an infrared temperature sensor can be used to measure the water stream's temperature directly without physically contacting the water stream. In other cases, the temperature representative of the water stream may be a measured temperature having some indirect but somewhat predictable relationship or some other relationship with the temperature of the water stream. For instance, a temperature probe may be attached to and measure the temperature of some plumbing fixture through which the water stream flows. As such a temperature related to the temperature of the water stream may be measured by a temperature sensor or component. In essence, a temperature representative of the water stream temperature may have some direct, indirect, or other relationship to the temperature of the water stream. As such, a number of temperatures representative of the water stream may be used within device embodiments according to the present invention.

Some examples of temperature sensors used by device embodiments of the present invention are illustrated as feature 210 in FIGS. 1, 2(a), 2(b), 2(c), and 2(d). The temperature sensors such as 210 used herein should be able at a minimum to measure temperatures directly or approximately related to the body temperatures measured in humans, such that comfort may be determined within some range of temperatures proximate to the temperatures that might feel comfortable. Alternatively, the temperature sensors could measure a much broader range of temperatures, such as a range of temperatures between very cold almost freezing water and very hot almost boiling water. In addition, the temperature sensors used in various device embodiments can be implemented in a number of ways since various temperature sensing technologies may be used to measure water temperature. A temperature sensor such as 210 in FIG. 1 or FIG. 2(a) for example may include one or more temperature sensor components selected from the group consisting of a thermometer, a temperature probe, a thermocouple, a thermistor, a varistor, an infrared temperature sensor, a resistance temperature detector probe, a thermojunctive temperature sensor, a temperature sensitive bridge circuit, a mechanical temperature sensor, a discrete temperature sensitive component, an integrated circuit temperature sensitive component, and the like. Some of these temperature sensor components may be used to measure the temperature of the water stream directly, such as by being in direct contact with or being immersed in the water stream, or by otherwise sensing the temperature of the water stream itself such as by using an infrared sensor. Some components of the temperature sensor such as 210 can be used to measure the temperature of a water stream indirectly, such as by measuring a temperature that has some relationship to the water stream. For example, the temperature of a showerhead through which the water stream flows can be measured to provide a temperature representative of a water stream. Yet other temperature sensor components measure the temperature of the water stream directly without direct physical contact. For example, the temperature of a water stream can be measured by using an infrared temperature sensor component pointed at or in the general direction of the water stream. Note that temperature sensor components may be used alone or in combination with other temperature sensor components in temperature sensors 210 various device embodiments. For instance a thermocouple and infrared temperature detector could both be used in a temperature sensor. Some temperature sensor components are used to provide more reliable temperature measurements. For instance, a temperature sensitive bridge circuit may be used to provide a reliable electric circuit implementation of a temperature sensor. The temperature sensor may be a standalone component, or may be implemented together with the control unit, the output device, the user interface, or with combinations thereof. Of course, as those skilled in the art will realize, many other ways of measuring the temperature of a water stream may be utilized in the present invention.

Next, we describe the operable connections according to various device embodiments of the present invention. First, it will also be understood that when an element of a device embodiment is referred to as being “connected”, “operably connected” or “coupled” to another element, it can be either directly connected or coupled to the other element or intervening elements may be present. For example, the temperature sensor may be operably coupled directly to the control unit, either directly or through an intervening circuit for example. In contrast, when an element is referred to as being “directly connected” or “directly coupled” to another element, then there are no intervening elements present. For example, the temperature sensor could be directly coupled to the control unit with no intervening parts.

As noted above, in some device embodiments a temperature sensor such as 210 is operably connected to at least a plumbing fixture such as 100 in FIGS. 1, 2(a), and 2(b) so that it can thereby sense a temperature representative of the water stream. Some examples of the many possible operable connections between the temperature sensor and the water stream are shown in FIG. 1 and in FIGS. 1, 2(b), 2(c), and 2(d) as operable connections 205(a)-205(d). Operable connections between the temperature sensor and the flowing water stream allow the temperature sensor to sense the water stream and determine a temperature representative of the water stream as discussed above. Of course, those skilled in the art may realize that other operable connections are possible within the scope of the present invention and its various device embodiments.

As shown by operable connection 205(a) illustrated as a dashed line in FIG. 1 and in FIG. 2(b), the temperature sensor may be attached directly to the plumbing fixture 100 through which water stream 50 flows. In this case, the temperature sensor does not sense the water stream directly but senses it indirectly through the plumbing fixture 100 such that there may be some temperature difference between the temperature representative of the water stream and the actual temperature of the water stream. Similarly, as illustrated by operable connection 205(b), the temperature sensor may sense the water stream indirectly by being attached to any known plumbing termination, such as 105 shown in the Figure, which may be used to ultimately deliver a water stream to a user. Again there may be some temperature difference between the temperature representative of the water stream and the actual temperature of the water stream. Alternatively, the temperature sensor may be mounted on the plumbing fixture, plumbing termination, or otherwise such that the temperature sensor is in direct contact with the water stream and may sense a temperature representative of the water stream. In this case, the actual temperature of the water stream may be measured directly. This operable connection is shown as 205(c) in the Figure for example. As such, the tip of operable connection 205(c) may contain some temperature probe or the like directly immersed in the water stream as shown. Further, some remote water temperature sensing technologies might be used to sense the temperature of the water stream, such as through an infrared sensor or the like. This example is shows as operable connection 205(d) in the Figure, in which the temperature sensor measures the actual temperature of the water stream through an infrared temperature sensor without being in direct contact therewith. Embodiments of the present invention work with any of these operable connections as well as with many other operable connections between the temperature sensor and the water stream such that a temperature representative of the water stream may be sensed.

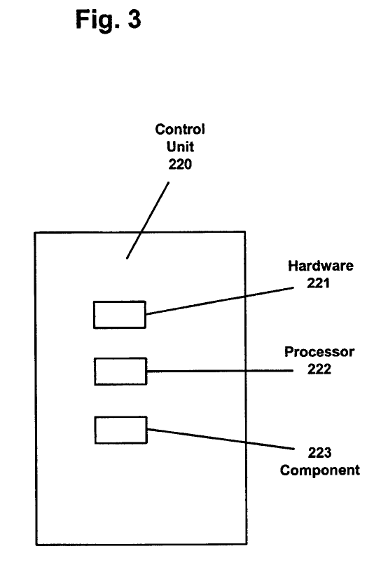

The control units that may be used in device embodiments according to the present invention will now be discussed. For example, a representative control unit is shown as control unit 220 in FIGS. 1 and 3. For purposes of the present invention, the control units used herein function to process temperatures representative of a water stream, such as water stream 50, at various points in time. For instance, the control unit may store or preset a temperature representative of the water stream when it is comfortable for a user. For example, a control unit may preset a comfortable water stream temperature. Alternatively, the control unit 220 may store or preset a water temperature range representative of the water stream such that the water stream therein is comfortable for the user to physically contact. For instance, a low temperature and a high temperature defining a comfortable water temperature range could be preset in some device embodiments. A range of temperatures above and below the temperature representative of the water stream at one point in time that is comfortable for the user to physically contact could also be stored or preset. The temperature representative or the preset range of temperatures representative of the water stream may be as sensed by temperature sensor, may just be input directly into the control unit 220, or may be input through the user interface 240 indirectly into the control unit. Optionally, the temperature representative or the preset water temperature range may be set through an output device such as 230, through a user interface such as 240, or in some other ways. In addition to storing or presetting a temperature representative, or a range of temperatures representative of the water stream, the control unit 220 can provide other functions. For example, control unit 220 can compare the temperature representative of the water stream sensed with the water temperature range preset by the user. As such, the control unit can determine whether the temperature representative of the water stream sensed is within the water temperature range or matches a single water temperature preset by the user as comfortable. When the control unit 220 determines the temperature representative of the water stream sensed to be within the water temperature range or matches the single water temperature preset by the user, the output device 230 may in response provide an affirmative indication to the user that the water stream is comfortable for the user to physically contact. Optionally, the control unit 220 may provide an indication to the output device that the temperature representative of the water stream sensed is within the water temperature range or matches the single water temperature preset by the user as being comfortable to physically contact. A user can thereby contact a water stream assured that the water temperature will be comfortable as preset for that user to physically contact.

A control unit such as 220 shown in FIGS. 1 and 3 may be implemented in many ways and using a number of technologies. The control unit 220 can operate to store a temperature representative of the water stream or a preset range of temperatures representative of the water stream that are comfortable for a user to contact physically. Further, the control unit can compare the preset temperature or temperature range to the realtime sensed temperature representative of the water stream. Lastly, a control unit may provide some indication that the realtime sensed temperature representative of the water stream matches or is within the range of preset temperatures representative of the water stream previously stored in the control unit, such that the output device may provide an affirmative indication that a water stream is comfortable to a user. The control unit 220 may be implemented all in hardware such as 221 in FIG. 3, all in a suitably programmed microprocessor such as 222 in FIG. 3, or alternatively using both hardware and a programmed microprocessor in combination, or in other ways, as those skilled in the art will understand. Accordingly, a control unit such as 220 may optionally include at least one component selected from the group consisting of hardware logic, a hardware logic component, a state machine implemented in hardware, an ASIC, an integrated circuit, a programmable logic device, a processor, a general purpose microprocessor, a microcontroller, a digital signal processor, a computer, an embedded controller, a digital signal processor (DSP), a programmable controller, a hybrid processor including a controller and a DSP therein, non-volatile storage, volatile storage, memory, registers, RAM, SRAM, DRAM, ROM, EEPROM, a configurable hardware device, and a re-configurable hardware device. For example, an optional component 223, such as one or more of the optional components listed above, is also shown in FIG. 3. Of course, a suitable computer software program may be loaded and executed within a processor used to support at least some of the various functions provided by a control unit 220. The control unit 220 may be a standalone component, or may be implemented together with the user interface, the output device, with the temperature sensor, or in combinations thereof.

In addition, in some device embodiments a control unit such as 220 is operably connected to at least a temperature sensor such as 210 for receiving therefrom the temperature representative of the water stream. An example of an operable connection between a control unit 220 and a temperature sensor 210 is shown in FIG. 1 as operable connection 215. Of course a control unit may be connected to elements of a device embodiment other than a temperature sensor. The operable connections between the control unit and the temperature sensor allow the control unit to receive realtime readings of the sensed temperature representative of the water stream and optionally to interact with the temperature sensor in other ways. The operable connection between the control unit and the temperature sensor may be implemented in various ways. The operable connection between the temperature sensor and the control unit may include at least one connection selected from the group consisting of a direct wired connection between the sensor and control unit, a wireless connection between the sensor and control unit, an infrared connection between the sensor and the control unit, an electromagnetic connection between the sensor and the control unit, a networked connection between the sensor and the control unit, a communication connection between the sensor and the control unit, a cellular phone connection between the sensor and the control unit, a fiber optic connection between the sensor and the control unit, and the like. In addition, other operable connections between the temperature sensor and the control unit may be used. Note further that the control unit may be directly connected to the temperature sensor, or alternatively the control unit may be indirectly connected to the temperature sensor through other intervening parts or elements of the device embodiment.

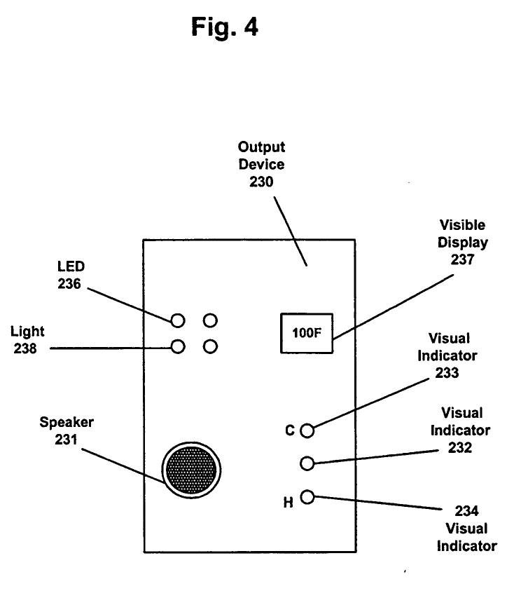

Device embodiments according to the present invention use therein an output device. For example, representative output devices are shown as feature 230 in FIGS. 1 and 4. For purposes of the present invention, the output devices such as 230 used herein function to interact or communicate with a user providing at a minimum an affirmative indication that the water stream is comfortable for the user to physically contact to a user. The affirmative indication is provided to the user when the control unit determines the temperature representative of the water stream sensed to be within the water temperature range preset by a given user. An output device such as 230 in FIGS. 1 and 4 may provide at least one of an audible sound indication and a visual indication to the user as an affirmative indication to the user that the water stream is comfortable in some embodiments. For example, an output device could be a speaker such as 231 producing an audible sound or voice, a light such as 238 or an LED such as 236 being illuminated, or possibly both an audible and visual indication may be provided. Of course, other visual indicators could be used as an output device, either alone or in combination with an audible indicator. For example, a visual indicator such as 232 or a visible display such as 237 might be used. A given user can select among one or more affirmative indications to be provided to indicate the sensing of a comfortable water stream in various embodiments. Depending on the given embodiment, either the same affirmative indication or different affirmative indications may be provided to different users. In some embodiments, a given user can select which one or more affirmative indications may be provided to them, while in other embodiments different affirmative indications may be assigned to different users such that an individual user may be advised that the water stream is comfortable for them to contact. The output device 230 may be a standalone component, or may be implemented together with the control unit, the user interface, the temperature sensor, or combinations thereof.

In additional embodiments, the output device 230 may further provide at least one additional indication beyond just an affirmative indication that the water stream is comfortable to physically contact. The output device may also issue affirmative indications that the water stream is uncomfortably hot, uncomfortably cold, or both at different times. For example, some embodiments may provide an audible indication that the temperature representative of the water stream is too uncomfortably hot when the control unit determines the temperature representative of the water stream to be above the water temperature range preset by the user. For instance, speaker 231 could produce a sound indicating that the water stream is too hot. Alternatively, a visible indication that the temperature representative of the water stream is too uncomfortably hot when the control unit determines the temperature representative of the water stream to be above the water temperature range preset by the user may be provided in embodiments. As such, visual indicator like 234 could be used to indicate that the water stream is too hot for comfort. For instance, some embodiments may provide an audible indication that the temperature representative of the water stream is too uncomfortably cold when the control unit determines the temperature representative of the water stream to be below the water temperature range preset by the user. As before, speaker 231 could produce a sound indicating that the water stream is too cold. Optionally, and a visible indication that the temperature representative of the water stream is too uncomfortably cold when the control unit determines the temperature representative of the water stream to be below the water temperature range preset by the user may be provided in some embodiments. Similarly, a visual indicator like 233 could be used to indicate that the water stream is too cold for comfort. As another illustrative example, a device embodiment may activate a green light when the water stream is within a comfortable water temperature range, a device embodiment could activate a red light when the water stream is uncomfortably hot, and a device embodiment can activate a blue light when the water stream is uncomfortably cold. Additionally or alternatively, a device embodiment may activate a first sound when the water stream is within a comfortable water temperature range, may activate a second sound when the water stream is uncomfortably hot, and may activate a third sound when the water stream is uncomfortably cold. Those skilled in the art will realize that many audible indicators, visual indicators, or both could be used to provide the functions described above. In addition, either the same indicator or different indicators may be provided for each user in various device embodiments. Of course, one or more of these indications may be activated either simultaneously or at different times by an output device such as 230 in a given device embodiment.

An output device such as feature 230 shown in the FIG. 1 and 4 may include one or more components that support the output device in providing an affirmative indication to one or more users of the present invention. In some embodiments, the affirmative indication provided by output device 230 may indicate to the user that the water stream is comfortable to physically contact. For example, a visual indicator such as 232 in FIG. 4 may be activated to indicate that the water is comfortable to contact. In other embodiments, in addition to an indication that the water stream is comfortable to contact, an output device may provide an affirmative indication that the water stream is either too hot or too cold to contact. For example, a visual indicator such as 233 in FIG. 4 may be activated to indicate that the water is too cold to comfortably contact. For instance, a visual indicator such as 234 in FIG. 4 may be activated to indicate that the water is too hot to comfortably contact. One function provided by the output device is to provide affirmative indications such as discussed above. Accordingly, an output device could contain components that allow it to provide a visible indication to a user, and audible indication to a user, or both in embodiments. Those skilled in the art will appreciate that this may be provided in many ways. The output device 230 in various embodiments could include one or more components selected from the group consisting of a piezoelectric source, a local speaker, a remote speaker, an audible sound source, a colored LED such as 236, a visible output display such as 237, an LCD panel, and a touch screen with visible output for interacting with the user, for example. These are merely but a few examples as those skilled in the art will realize. Of course, indications could be provided to the user locally or remote from the device embodiments. Indications could be provided to a user locally in reasonable proximity with a device embodiment such that the user receives an affirmative indication directly from the output device. For example, a user may see a light or hear a sound within some reasonable proximity to the output device. Alternatively, the user could be somewhat removed from the device embodiment such that it receives an affirmative indication indirectly through some other device, such as through a mobile phone, landline telephone, pager, Personal Digital Assistant, Personal Computer, or the like. Of course, those blessed with skill in the art will understand that many other possible output device permutations and combinations are possible without departing from the scope of the present invention.

For some device embodiments an output device such as 230 is operably connected to at least a control unit such as 220 for receiving therefrom information regarding comparisons of the realtime water stream sensed against the water temperature range preset by at least one user. Of course an output device 230 may be connected to elements of a device embodiment other than a temperature sensor. In addition, in some embodiments the output device 230 may optionally interact and be operably connected to a temperature sensor 210, a user interface 240, both, or combinations thereof in addition or in lieu of being operably connected to control unit 220. See for example the various operable connections that may be provided either individually or in combinations as shown in FIG. 1. An example of an operable connection between an output device 230 and a control unit 220 is shown in the Figure as operable connection 225. The control unit compares the temperature representative of the water stream sensed with the water temperature range preset by the user. The operable connection between the control unit and the output device permit the output device to provide an affirmative indication to the user that the water stream is comfortable for the user to physically contact when the control unit determines the temperature representative of the water stream sensed to be within the water temperature range preset by the user. Providing the affirmative indication of a comfortable water stream to a user such as 10 is one benefit provided by the present invention. The operable connection between the output device 230 and the control unit 220 may be implemented in various ways. The operable connection between the output device and the control unit may include at least one connection selected from the group consisting of a direct wired connection between the output device and control unit, a wireless connection between the output device and control unit, an infrared connection between the output device and the control unit, an electromagnetic connection between the output device and the control unit, a networked connection between the output device and the control unit, a communication connection between the output device and the control unit, a cellular phone connection between the output device and the control unit, a fiber optic connection between the output device and the control unit, and the like. Further, other operable connections between the output device and the control unit may be used. As above, the control unit may be directly connected to the output device, or alternatively the control unit may be indirectly connected to the output device through other intervening parts or elements of the device embodiment.

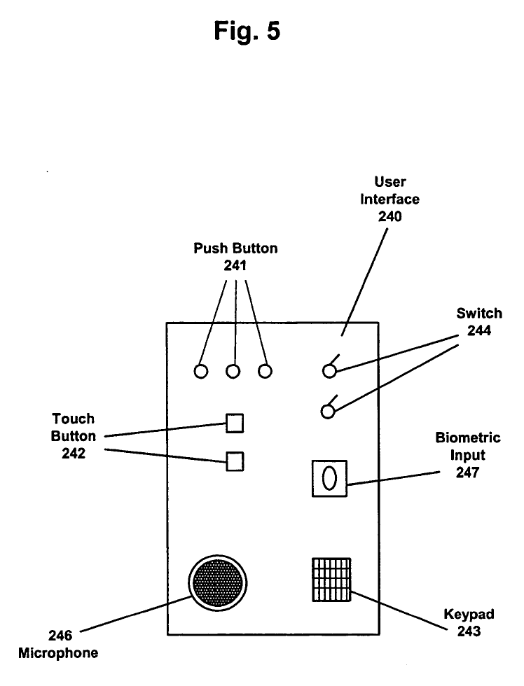

A user interface such as 240 is an option provided in some device embodiments according to the present invention. As discussed previously, a user interface such as 240 shown in FIGS. 1 and 5 for illustration is optional and is not required in all embodiments of the present invention since it is possible to preset a water temperature or water temperature range into the control unit 220. For purposes of the present invention, the user interfaces used herein merely provide a more user-friendly facility through which one or more users can interact with the control unit. Through a user interface such as 240, one or more users may at a minimum preset a water temperature or water temperature range that is comfortable for each user to physically contact. The user interface may be a standalone component, or may be implemented together with the control unit, the output device, the temperature sensor, or in combinations thereof.

For example, representative user interfaces are shown as feature 240 in FIGS. 1 and 5. The user interface may be implemented in many ways including in hardware, a computer processor executing a suitable software program, combinations thereof, or the like. The user interface 240 could be relatively simple, such as push buttons 241, touch buttons 242, a keypad 243, or switches 244 through which one or more water temperatures could be selected and preset. It could optionally include a small visible output display such as those described for the output device herein, one or more lights or LED's, an LCD display, a touch screen with visible output, or the like for visually interacting with the user. A user interface used in various embodiments may include one or more of a push button, a switch, a visual display, a voice recognition interface, a sound activated interface, a touch screen display, a voice generating interface, an infrared remote control interface, a network interface, a communication interface, an optical interface, a wireless interface, a cellular phone interface, a biometric interface, and the like. Optionally, a GUI (graphical user interface) could be provided at the device embodiment itself or at a remote computer processor or the like connected to the device embodiment for user interaction. As another option, a user interface could be provided to allow interfacing through a telephone, mobile phone, or the like. Alternatively, a user interface 240 could provide some audible output and or input such that a user could interact with a device embodiment in presetting one or more water stream temperatures. The user interface could include a speaker or other ways to provide audible output, as well as a microphone such as 246, or other ways to collect audible or sound input. In addition, the user interface could optionally include means for accepting biometric input from a user, such as fingerprint scanner 247 for example. The user interface may be share visible output and audible output elements with the output device in some embodiments, and a user interface may share some physical input or audible input facilities with the control unit or other parts of the overall device in other embodiments. The above are merely a few examples of the possibilities for a user interface such as 240. Those of skill in this art will fully appreciate that there are many options with respect to the user interfaces that may be used in various device embodiments, all without departing from the scope of the present invention. All that is required is that the user interface provides an optional and possibly more user friendly mechanism through which a user may interact with device embodiments provided by the present invention. Next, we will discuss some operational aspects of user interfaces used in various device embodiments of the present invention.

Various device embodiments include user interfaces such as 240 for example, that provide support for various user related functions. For instance, a user interface such as 240 could provide one or more functions such as allowing a single user to set a single water temperature comfort range setting interface, allowing a single user to set multiple water temperature comfort range settings interface, allowing multiple users to set a single water temperature comfort range setting apiece interface, allowing multiple users to set multiple water temperature comfort range settings interface, and the like. As such, a user interface 240 should be able to support the temperature presetting needs of one or more users of a device embodiment. In addition, various user interfaces used in device embodiments provide an interface for a user physically contacting a water stream to set at least one of a comfortable water setting, a coldest comfortable water setting, a too cold water setting, a hottest comfortable water setting, a too hot water setting, and the like. In other embodiments, the user interface may provide an interface for a user allowing the control unit to identify at least one user and at least one water temperature comfort range setting associated with each user, such that the control unit can utilize the user data and associated water temperature comfort range data. Further, in device embodiments the user interface such as 240 can provide an interface for a user including at least one feature selected from the group consisting of a power on feature for powering on the device, an automatic power off feature for the device, a manual power off feature for the device, an automatic power on feature for the device, and a low power indication feature for the device. In addition, a user identification feature, a water temperature comfort range setting customization feature, and the like, may be provided in some device embodiments. Of course, many other implementations of user interfaces such as 240 are possible within the scope of the present invention.

The user interface 240 may be operably connected to at least one of the temperature sensor 210, the control unit 220, and the output device 230 in various distinct device embodiments. Examples of some possible operable connections between a user interface 240 and various elements of a device embodiment are shown as operable connections 235(a), 235(b), 235(c), and 235(d) in FIG. 1 respectively with the output device, with both the control unit and the output device, with the control unit, and with both the control unit and the temperature sensor are shown in the Figure. Of course a user interface 240 may be connected to multiple elements of a device embodiment. The operable connection between the user interface and one or more of the temperature sensor, the output device, and the control unit may be implemented in various ways. The operable connection between the output device and the other elements of the device embodiment may include at least one connection selected from the group consisting of a direct wired connection between the output device and control unit, a wireless connection between the output device and control unit, an infrared connection between the output device and the control unit, an electromagnetic connection between the output device and the control unit, a networked connection between the output device and the control unit, a communication connection between the output device and the control unit, a cellular phone connection between the output device and the control unit, a fiber optic connection between the output device and the control unit, and the like. Those skilled in the art will appreciate that other operable connections may be used for the user interface 240 without departing from the present invention. In addition, note that the user interface may be directly connected to the other elements of the device embodiment. Alternatively, the user interface may be indirectly connected to the other elements of the device embodiment through other intervening parts or elements of the device embodiment.

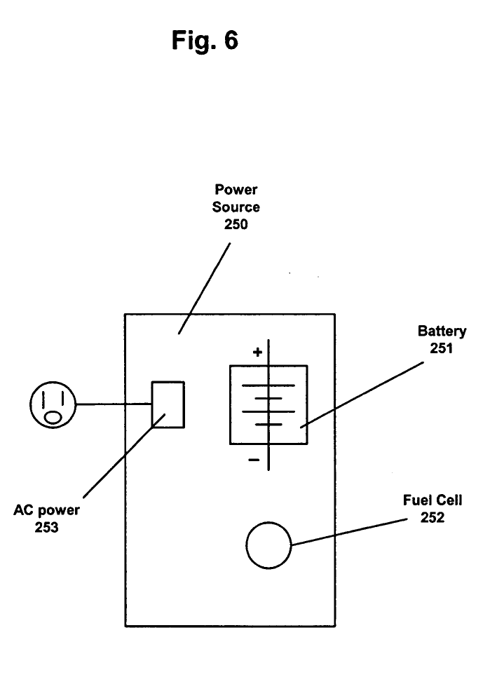

The present invention requires a power source, and there are various possible power sources that may be used in various device embodiments. A power source, such as example power source 250 in FIGS. 1 and 6, may power one or more of the elements of a device embodiment, such as control unit 220, temperature sensor 210, output device 230, user interface 240, and the like. The power source 250 should be safe for users to use in an environment likely to be damp and wet given the interaction with a water stream. Some given device embodiments have a power source 250 that provides controlled voltage, controlled current, or both for powering the device and/or its elements. The power source 250 could provide AC or DC power and could be sourced directly or indirectly from electrical power provided in a home or building. For example, a power source 250 could be AC powered such as through 253. Power source 250 could be sourced from AC power directly or through AC power that is rectified or regulated into DC. Alternatively, a power source such as 250 in FIG. 6 could comprise or include a battery 251, fuel cell 252, or the like that may be independent of the electrical power provided in a home or building. In addition, the power source 250 could include combinations of the preceding such that device embodiments could be powered even during a blackout or other condition causing loss of a power source, such as by having a battery or generator backup. In embodiments, the power source may include one or more components selected from the group consisting of a battery such as 251, a low voltage DC power source, a current limited AC powered source, a current limited DC powered source, a voltage limited AC powered source, a voltage limited DC power source, a chemical power source, a fuel cell power source, and the like. The power source 250 used in some embodiments could power the entire device embodiment or only one or more parts of a device embodiment. For example, the temperature sensor and the power unit have a power source selected from the group consisting of a single common shared power source, two related power sources, and two independent power sources. Similarly, various power designs can be used to power the control unit, temperature sensor, output device, user interface, and the like. Many power design options are possible given design points such as the level of backup required or the cost and important allotted to the power subsystem.

To conserve power, some device embodiments may normally be powered off. In addition, to save power, some device embodiments should be turned off after the user is no longer contacting the water stream. For one device embodiment, the device may be turned on and off by interacting with a user. In another, a user need only turn the device embodiment on. Yet other embodiments turn the device embodiment off after a period of time, turn the device off once after the water stream no longer flows, turn the device off once the water stream temperature is below the low end of the range for some period of time, or turn the device off using combinations thereof. In some cases, the device embodiment may be turned on and off by sensing the water stream, sensing temperature differentials associated with the flow of a water stream, or the like. In addition, once the water temperature has been indicated to be comfortable for a user, in some embodiments the device can be turned off automatically without impacting a user's comfort. Again, those skilled in the art will know that many permutations and combinations are possible for turning a device embodiment on and off in accordance with the present invention.

Next we describe details regarding device embodiments and the environments in which they interact with a user. First, a device embodiment must be substantially water tight or otherwise suitable for use in moist and damp environments in which contact with a water stream is assumed. In addition, the power subsystem must take into consideration not only the moist environment but also the safety of each user. Further, some device embodiments can be installed without requiring substantial modification to existing plumbing. Other device embodiments do not require substantial plumbing disassembly, while others do not significantly modify existing plumbing connections, the fluid flow path, or both. In several device embodiments, the device may be retrofitted onto pre-existing plumbing without substantially altering the existing plumbing and the plumbing fixture. In some cases, a device embodiment may be installed using clamps, clips, suction cups, simple hardware, or the like such that a typical user can install the device without having special handyman or plumbing skills. For several embodiments, only relatively simple tools available to most users are necessary for device installation. At times, a device embodiment may be easily installed as part of a new plumbing installation into some premises under construction. In other cases, a device embodiment may be installed integrated into existing plumbing that may require some plumbing modifications. Accordingly, a number of device embodiments may be integrated into plumbing and the plumbing fixture with substantial alterations for integrating the device into plumbing, the plumbing fixture, or possibly both.

Many modifications and other embodiments of the present invention will come to mind to one skilled in the art to which this invention pertains having the benefit of the teachings presented in the foregoing descriptions and the associated figures. Therefore, it is to be understood that the invention is not to be limited to the specific embodiments disclosed and that modifications and other embodiments are intended to be included within the scope of the appended claims. In addition, those skilled in the art will appreciate that various features and aspects of the above disclosed embodiments, whether preferred or not, may be combined to create a number of other related embodiments that are still within the scope of the present invention. As noted, the above written description of the present invention is meant to disclose and fully describe the present invention, and is not meant to limit or narrow the present invention defined by the following claims. Although specific terms are employed herein, they are used in a generic and descriptive sense only and not for purposes of limiting the scope of the present invention in any way.

What is claimed is:

1. A device for indicating whether a water stream flowing through a plumbing fixture is comfortable for a user to physically contact, comprising;
a temperature sensor, operably connected to at least the plumbing fixture and thereby sensing a temperature representative of the water stream;
a control unit, operably connected to at least the temperature sensor for receiving therefrom the temperature representative of the water stream;
an output device, operably connected to at least the control unit;
wherein the output device providing at least one of an audible sound indication and a visual indication to the user;
a user interface, operably connected to at least one of the temperature sensor, the control unit, and the output device for allowing the user to preset a water temperature range representative of the water stream such that the water stream therein is comfortable for the user to physically contact;
wherein the control unit compares the temperature representative of the water stream sensed with the water temperature range preset by the user;
wherein the output device provides an affirmative indication to the user that the water stream is comfortable for the user to physically contact;
when the control unit determines the temperature representative of the water stream sensed to be within the water temperature range preset by the user; and
wherein the water stream is previously mixed to some temperature prior to interfacing with the device through the plumbing fixture.

2. The device of claim 1, wherein the output device includes at least one component selected from the group consisting of a piezoelectric source, a local speaker, a remote speaker, an audible sound source, a colored LED, an LCD panel, a visible output display, a visible indicator, a light, and a touch screen with visible output for interacting with the user.

3. The device of claim 1, wherein the output device further provides at least one additional indication selected from the group consisting of an audible indication that the temperature representative of the water stream is too uncomfortably hot when the control unit determines the temperature representative of the water stream to be above the water temperature range preset by the user, a visible indication that the temperature representative of the water stream is too uncomfortably hot when the control unit determines the temperature representative of the water stream to be above the water temperature range preset by the user, an audible indication that the temperature representative of the water stream is too uncomfortably cold when the control unit determines the temperature representative of the water stream to be below the water temperature range preset by the user, and a visible indication that the temperature representative of the water stream is too uncomfortably cold when the control unit determines the temperature representative of the water stream to be below the water temperature range preset by the user.

4. The device of claim 1, wherein the temperature sensor includes at least one component selected from the group consisting of a thermometer, a temperature probe, a thermocouple, a thermistor, a varistor, an infrared temperature sensor, a resistance temperature detector probe, a thermojunctive temperature sensor, a temperature sensitive bridge circuit, a mechanical temperature sensor, a discrete temperature sensitive component, and an integrated circuit temperature sensitive component.

5. The device of claim 1, wherein the control unit includes at least one component selected from the group consisting of hardware logic, a hardware logic component, a state machine implemented in hardware, an ASIC, an integrated circuit, a programmable logic device, a processor, a general purpose microprocessor, a microcontroller, a digital signal processor, a computer, an embedded controller, a digital signal processor (DSP), a programmable controller, a hybrid processor, non-volatile storage, volatile storage, memory, registers, RAM, SRAM, DRAM, ROM, EEPROM, a configurable hardware device, and a re-configurable hardware device.

6. The device of claim 1, further comprising a power source, operably connected for providing controlled voltage and controlled current to at least one of the control unit and the temperature sensor, and wherein the power source is safe for the user to use in association with the water stream.

7. The device of claim 6, wherein the power source includes at least one component selected from the group consisting of a battery, a low voltage DC power source, a current limited AC powered source, a current limited DC powered source, a voltage limited AC powered source, a voltage limited DC power source, a chemical power source, and a fuel cell power source.

8. The device of claim 6, wherein the temperature sensor and the power unit have a power source selected from the group consisting of a single common shared power source, two related power sources, and two independent power sources.

9. The device of claim 1, wherein the operable connection between the temperature sensor and the water stream includes at least one connection selected from the group consisting of a direct connection in which the temperature sensor is in contact with the water stream, an indirect connection in which the temperature sensor is in indirect contact with the water stream but in direct contact with plumbing carrying the water stream, and an indirect infrared connection in which the temperature sensor can detect infrared energy from the water stream without being in contact with the water stream and without being in contact with plumbing carrying the water stream.

10. The device of claim 1, wherein the operable connection between the temperature sensor and the control unit includes at least one connection selected from the group consisting of a direct wired connection, a wireless connection, an infrared connection, an electromagnetic connection, a networked connection, a communication connection, a cellular phone connection, and a fiber optic connection.

11. The device of claim 1, wherein the operable connection between the control unit and the output device includes at least one connection selected from the group consisting of a direct wired connection, a wireless connection, an infrared connection, an electromagnetic connection, a networked connection, a communication connection, a cellular phone connection, and a fiber optic connection.

12. The device of claim 1, wherein the operable connection between the user interface and a least one of the temperature sensor, the control unit, and the output device includes at least one connection selected from the group consisting of a direct wired connection, a wireless connection, an infrared connection, an electromagnetic connection, a networked connection, a communication connection, a cellular phone connection, and a fiber optic connection.

13. The device of claim 1, wherein the user interface provides an interface for a user selected from the group consisting of allowing a single user to set a single water temperature comfort range setting interface, allowing a single user to set multiple water temperature comfort range settings interface, allowing multiple users to set a single water temperature comfort range setting apiece interface, and allowing multiple users to set multiple water temperature comfort range settings interface.

14. The device of claim 1, wherein the user interface provides an interface for a user physically contacting a water stream to set at least one of a comfortable water setting, a coldest comfortable water setting, a too cold water setting, a hottest comfortable water setting, and a too hot water setting.

15. The device of claim 1, wherein the user interface provides an interface for a user allowing the control unit to identify at least one user and at least one water temperature comfort range setting associated with each user, and wherein the control unit can utilize the user data and associated water temperature comfort range data.

16. The device of claim 1, wherein the user interface provides an interface for a user including at least one feature selected from the group consisting of a push button, a touch button, a keypad, a switch, a visual display, a voice recognition interface, a sound activated interface, a microphone, a touch screen display, a voice generating interface, an infrared remote control interface, a network interface, a communication interface, an optical interface, a wireless interface, a cellular phone interface, and a biometric interface.

17. The device of claim 1, wherein the user interface provides an interface for a user including at least one feature selected from the group consisting of a power on feature, an automatic power off feature, a manual power off feature, an automatic power on feature, a low power indication feature, a user identification feature, and a water temperature comfort range setting customization feature.

18. The device of claim 1, wherein the device is retrofitted onto pre-existing plumbing without substantially altering the existing plumbing and the plumbing fixture.

19. The device of claim 1, wherein the device is integrated into plumbing and the plumbing fixture with substantial alterations for integrating the device with plumbing and the plumbing fixture.

20. A device for indicating whether a water stream flowing through a plumbing fixture is comfortable for a user to physically contact, comprising;
means for sensing temperature operably connected to at least the plumbing fixture and thereby sensing a temperature representative of the water stream;
means for controlling, operably connected to at least the means for sensing temperature to receive therefrom the temperature representative of the water stream sensed;
means for interfacing, operably connected to at least the means for controlling for allowing the user to preset a water temperature range such that the water stream within the water temperature range is comfortable for the user to physically contact;
wherein the means for controlling compares the temperature representative of the water stream sensed with the water temperature range preset by the user;
means for outputting, operably connected to at least the means for controlling;
wherein the means for outputting provides at least one of an audible sound indication and a visual indication;
wherein the means for outputting affirmatively indicates to the user that the water stream is comfortable for the user to physically contact when the representative temperature of the water stream sensed is within the water temperature range preset by the user; and
wherein the water stream is previously mixed to some temperature prior to interfacing with the device through the plumbing fixture.

21. A device for indicating whether a water stream flowing through a plumbing fixture is comfortable for a user to physically contact, comprising;
a temperature sensor, operably connected to at least the plumbing fixture and thereby sensing a temperature representative of the water stream;
a control unit, operably connected to at least the temperature sensor for receiving therefrom the temperature representative of the water stream sensed;
wherein the control unit comparing the temperature representative of the water stream sensed with a water temperature range previously preset by the user as comfortable to physically contact;
an output device, operably connected to at least one of the control unit and the temperature sensor; and
wherein the output device affirmatively indicates to the user that the water stream sensed is comfortable for the user to physically contact;
when the representative temperature of the water stream sensed is within the water temperature range preset by the user.

22. The device of claim 21, wherein the output device includes at least one component selected from the group consisting of a piezoelectric source, a local speaker, a remote speaker, a colored LED, an LCD panel, a visible display, a visual indicator, a light, and a touch screen with visible output for interacting with the user.

23. The device of claim 21, wherein the output device further provides at least one additional indication selected from the group consisting of an audible indication that the temperature representative of the water stream is too uncomfortably hot when the control unit determines the temperature representative of the water stream to be above the water temperature range preset by the user, a visible indication that the temperature representative of the water stream is too uncomfortably hot when the control unit determines the temperature representative of the water stream to be above the water temperature range preset by the user, an audible indication that the temperature representative of the water stream is too uncomfortably cold when the control unit determines the temperature representative of the water stream to be below the water temperature range preset by the user, and a visible indication that the temperature representative of the water stream is too uncomfortably cold when the control unit determines the temperature representative of the water stream to be below the water temperature range preset by the user.

24. The device of claim 21, wherein the temperature sensor includes at least one component selected from the group consisting of a thermometer, a temperature probe, a thermocouple, a thermistor, a varistor, an infrared temperature sensor, a resistance temperature detector probe, a thermojunctive temperature sensor, a temperature sensitive bridge circuit, a mechanical temperature sensor, a discrete temperature sensitive component, and an integrated circuit temperature sensitive component.

25. The device of claim 21, wherein the control unit includes at least one component selected from the group consisting of hardware logic, a hardware logic component, a state machine implemented in hardware, an ASIC, an integrated circuit, a programmable logic device, a processor, a general purpose microprocessor, a microcontroller, a digital signal processor, a computer, an embedded controller, a digital signal processor (DSP), a programmable controller, a hybrid processor, non-volatile storage, volatile storage, memory, registers, RAM, SRAM, DRAM, ROM, EEPROM, a configurable hardware device, and a re-configurable hardware device.

26. The device of claim 21, further comprising a power source, operably connected for providing controlled voltage and controlled current to at least one of the control unit and the temperature sensor, and wherein the power source is safe for the user to use in association with the water stream.

27. The device of claim 26, wherein the power source includes at least one component selected from the group consisting of a battery, a low voltage DC power source, a current limited AC powered source, a current limited DC powered source, a voltage limited AC powered source, a voltage limited DC power source, a chemical power source, and a fuel cell power source.

28. The device of claim 26, wherein the temperature sensor and the power unit have a power source selected from the group consisting of a single common shared power source, two related power sources, and two independent power sources.

29. The device of claim 21, wherein the operable connection between the temperature sensor and the water stream includes at least one connection selected from the group consisting of a direct connection in which the temperature sensor is in contact with the water stream, an indirect connection in which the temperature sensor is in indirect contact with the water stream but in direct contact with plumbing carrying the water stream, and an indirect infrared connection in which the temperature sensor can detect infrared energy from the water stream without being in contact with the water stream and without being in contact with plumbing carrying the water stream.

30. The device of claim 21, wherein the operable connection between the temperature sensor and the control unit includes at least one connection selected from the group consisting of a direct wired connection, a wireless connection, an infrared connection, an electromagnetic connection, a networked connection, a communication connection, a cellular phone connection, and a fiber optic connection.

31. The device of claim 21, wherein the operable connection between the control unit and the output device includes at least one connection selected from the group consisting of a direct wired connection, a wireless connection, an infrared connection, an electromagnetic connection, a networked connection, a communication connection, a cellular phone connection, and a fiber optic connection.

32. The device of claim 21, further comprising a user interface operably connected to at least one of the temperature sensor, the control unit, and the output device for allowing the user to preset a water temperature range representative of the water stream comfortable for the user to physically contact.

33. The device of claim 32, wherein the operable connection between the user interface and a least one of the temperature sensor, the control unit, and the output device includes at least one connection selected from the group consisting of a direct wired connection, a wireless connection, an infrared connection, an electromagnetic connection, a networked connection, a communication connection, a cellular phone connection, and a fiber optic connection.

34. The device of claim 33, wherein the user interface provides an interface for a user selected from the group consisting of allowing a single user to set a single water temperature comfort range setting interface, allowing a single user to set multiple water temperature comfort range settings interface, allowing multiple users to set a single water temperature comfort range setting apiece interface, and allowing multiple users to set multiple water temperature comfort range settings interface.

35. The device of claim 33, wherein the user interface provides an interface for a user allowing the identification of at least one user and at least one water temperature comfort range setting associated with each user, and wherein the control unit can utilize the user data and the associated water temperature comfort range data.

36. The device of claim 33, wherein the user interface provides an interface for a user including at least one feature selected from the group consisting of a push button, a touch button, a keypad, a switch, a visual display, a voice recognition interface, a sound activated interface, a microphone, a touch screen display, a voice generating interface, an infrared remote control interface, a network interface, a communication interface, an optical interface, a wireless interface, a cellular phone interface, and a biometric interface.

37. The device of claim 33, wherein the user interface provides an interface for a user including at least one feature selected from the group consisting of a power on feature, an automatic power off feature, a manual power off feature, an automatic power on feature, a low power indication feature, a user identification feature, and a water temperature comfort range setting customization feature.

38. The device of claim 21, wherein the device is retrofitted onto pre-existing plumbing without substantially altering the existing plumbing and the plumbing fixture.

39. The device of claim 21, wherein the device is integrated into plumbing and the plumbing fixture with substantial alterations for integrating the device with plumbing and the plumbing fixture.

40. The device of claim 21, wherein the water stream is previously mixed to some temperature prior to interfacing with the device through the plumbing fixture.

41. A device for indicating whether a water stream flowing through a plumbing fixture is comfortable for a user to physically contact, comprising;
means for sensing temperature, operably connected to at least the plumbing fixture and thereby sensing a temperature representative of the water stream;
means for controlling, operably connected to at least the means for sensing temperature to receive therefrom the temperature representative of the water stream sensed;
wherein the means for controlling compares the temperature representative of the water stream sensed with a water temperature range previously preset by the user as comfortable to physically contact;
means for outputting, operably connected to at least the means for controlling; and
wherein the means for outputting affirmatively indicates to the user that the water stream is comfortable for the user to physically contact when the representative temperature of the water stream sensed is within the water temperature range preset by the user.
